(19) United States
(12) Patent Application Publication
(10) Pub. No.: US 2010/0154614 A1
(43) Pub. Date: Jun. 24, 2010

(54) Method and device for vibration Assisted scribing process on a substrate

(75) Inventors: Yunn-Shiuan Liao, Taipei City (TW); Yu-Sheng Hsu, Taipei City (TW); Saw Chi Mya, Taipei City (TW)

Correspondence Address: BACON & THOMAS, PLLC, 625 SLATERS LANE, FOURTH FLOOR, ALEXANDRIA, VA, 22314-1176, US

(73) Assignee: LIAO, Yunn-Shiuan, Taipei City (TW)

(21) Appl. No.: 12/591,811

(22) Filed: Dec. 2, 2009

(30) Foreign Application Priority Data
Dec. 18, 2008 (TW) 97149349

(51) Int. Cl. B26D 3/08; B26F 3/00

(52) U.S. Cl. 83/880; 225/2; 225/96; 83/886

(57) ABSTRACT

The present invention provides a vibration assistant scribing apparatus for generating an indentation having a median crack of a depth on a substrate and the method for the same. The provided vibration assistant scribing apparatus includes a clamping device clamping a scribing wheel for scribing the substrate; a moving pedestal having a pressure device configured thereon, the pressure device providing a pressure to the scribing wheel through the clamping device; and a vibration generator configured on the clamping device and providing a vibration force to the scribing wheel through the clamping device, so as to increase the depth of the median crack thereby.

### BACKGROUND OF THE INVENTION

1. Field of the Invention

The present invention relates to a scribing method and apparatus for scribing a substrate; and more particularly, to a vibration assistant scribing method and apparatus for a substrate.

2. Description of the Prior Art

For the flat panel display industry, TFT-LCD panels are the most important products which account for about 70% output value. In this case, there is an increasing demand in the complicated process for TFT-LCD to reduce the product and processing cost as possible. Specifically, the process for TFT-LCD involves three principle stages, an array stage, a cell stage and a module stage. The cell stage is a post process in which a TFT-LCD mother glass is cut into a final size as desired for a panel, and the cutting technique may significantly affect the quality and processing cost of a TFT-LCD panel.

At present, the cutting technique includes the two separate process, scribing and breaking. With reference to FIG. 1, the scribing process for the glass substrate is schematically shown. In the scribing process, a scribing wheel 16, which is made of super hard material, is applied to generate a wheel indentation 10 on the glass substrate by rolling thereon. Such wheel indentation 10 is constituted by continuous cracks. As shown in FIG. 1, the scribing wheel 16 is driven by a moving pedestal (not shown) to move in the direction shown by the arrow, and thus scribing the surface of the glass substrate to form the wheel indentation 10 thereon. In the breaking process, a pressure is applied on the cracks to make them separate. Between the scribing and breaking processes, it is the scribing process that is critical to the cutting technique since a variety of cracks and defects may arise in such process. With reference to FIG. 2, a cross sectional view of a glass substrate after the scribing process is shown. When the scribing wheel 16 passing across the glass substrate, a wheel indentation 10 is first formed on the surface of glass substrate, which further brings the local plastic deformation in the substrate, as referred to plastic deformation zone 11. The plastic deformation zone 11 results in cracks including the median crack of a vertical direction 13, the lateral crack 14 horizontally extending in sub-surface level, the chipping 12 caused by the lateral crack 14 and its extension to the surface, and the radial crack 15 (as shown in FIG. 4). Depending on the edge shape, the scribing wheels are divided into two typical types including a standard type and a tooth type, in which the standard type scribing wheel is a scribing wheel having no teeth on the knife edge thereof, and the tooth type scribing wheel is a scribing wheel having periodically excavating grooves at the knife edge thereof, as shown in FIG. 3.

The depth of the median crack 13 is the most important determined basis related to the merits of the entire cutting process. In addition, the chipping 12, the lateral crack 14 and radial crack 15, are also important factors resulting in poor quality of the cut LCD panel.

The merits of the scribing process can be determined by the following three methods. The first relates to the depth of the median crack 13, in which the deeper the median crack 13 is, the easier the breaking process is. Typically, if a smooth breaking is desired, the thickness of the median crack 13 must be at least more than one-tenth of the glass substrate. If the median crack is deep enough, the breaking process may be omitted, since the glass substrate will break due to the weight itself. The second depends on whether the lateral crack 14 occurs or not. Since serious lateral cracks 14 may cause the breakdown at the scribing edge 12, and the small glass substrate debris resulting therefrom may fall onto the cut platform, and thus affect the subsequent scribing operation and increase the period required for polishing the edge of substrate. Therefore the lateral crack should be avoided. As to the third one, it is related to the bending strength of the cut edge. In addition to the defects observable by an optical microscopy, there is still some defects which are not observable but could affect the anti-bending strength of the cut edge. The substrate may break from the cut edge to the internal during transportation or being used in a bad environment, so the bending strength test must be proceeded to ensure the quality therefor. In views of the above, it is concluded that the median crack 13 may improve the whole cutting process, while the lateral cracks 14, chipping 12 and radial crack 15 may viciously affects the whole cutting process.

It is found the scribing wheel may be the critical factor for the above three cracks and/or chipping. As mentioned, the scribing wheels can be divided into standard type and tooth type, depending on the knife edge. One example of the tooth type scribing wheel (penett) is available from Mitsubishi Diamond Industrial Co., LTD, as disclosed in U.S. Pat. No. 5,836,229 and U.S. Pat. No. 6,796,212B2, by which the glass substrate can break automatically without needing an additional breaking process. As to the standard type, since the depth of the median crack 13 created by a standard scribing wheel is limited to the emergence of lateral cracks 14 and cannot further increase, a breaking process must be carried out after the scribing process. Therefore, the tooth type scribing wheel is more advantageous than the standard type. Nevertheless, the tooth type scribing wheel is relatively expensive and must be configured with a scribing machine. Besides, a possible drawback of the tooth type scribing wheel is the generation of radial cracks 15, which reduces the bending strength of glass substrate significantly, as shown in FIG. 5.

The advantages and disadvantages of respective standard type scribing wheel and (similar to) tooth type scribing wheel are listed in the following table.

| Type of | | | | Max. | |
|---|---|---|---|---|---|
| scribing | Median | Lateral | | bending | |
| wheel | crack | crack | Chipping | strength | Cost |
| Standard type | Lower speed | Occur with | Not easily | Strong | High, |
| | with | increasing | happen | | needing the |
| | increasing | loading | | | breaking |
| | loading | | | | process and |
| | | | | | equipment |
| (similar to) | Directly | Do not | Easily | Half of that | The price of |
| tooth type | penetrate | occur until | happen | of the | scribing |
| | the | the glass is | | standard | wheel is |
| | thickness of | penetrated | | type | high, |
| | glass | | | | needing to |
| | | | | | be |
| | | | | | configured |
| | | | | | with machine |

Based upon the conventional calculation method for the median crack 13, it is found the median crack 13 generated by a tooth type scribing wheel is not significantly deep, but is deep enough to make the glass substrate completely break. It is because the stress status of the tooth type scribing wheel will vary in the vicinity of the knife mark. Similar to the standard type, the tooth type scribing wheel has a sharp knife, but in the groove area of the scribing wheel, the knife portion is removed deliberately. In this case, the wheel indentation is not continuous, but becomes on and off. The tooth and grooves of the tooth type scribing wheel may contact with the glass substrate while the scribing wheel is rolling thereon, and the tooth part may pierce the surface of glass substrate and thus the cracks form. Further, a trench is formed on the surface of glass substrate since the depth of the median crack 13 is enhanced by changing the stress state around the tooth. In this case, it is a possible way to overcome the limitation relating to the depth of median crack for the standard wheel by adjusting the distribution of stress. One possible method is to adjust the stress distribution under the scribing wheel by use of a vibration assistant apparatus, for example, available from Japanese THK Co., Ltd and Beldex Corporation, as disclosed in U.S. Pat. No. 6,832,439B2, U.S. Pat. No. 6,536,121B1, U.S. Pat. No. 6,460,257B1 and U.S. Pat. No. 6,478,206 B2, respectively. In such designs, however, the indentation is generated by a pyramid-shaped indentation device combined with vibration to produce intensive but not continuous indentations, which is different from the continuous indentations generated by scribing of the scribing wheel. Thus, the existing vibration assistant technique is not aimed to the scribing wheel. In other words, the designs and effects of vibration assistant scribing has not been verified yet.

In views of the above, a novel design of vibration assistant scribing apparatus for a glass substrate and a method for the same are provided, which has the advantages of both the standard type and tooth type, and the disadvantages thereof are avoided.

### SUMMARY OF THE INVENTION

In views of the above, it is one aspect of the present invention to provide a vibration assistant scribing apparatus and a method for the same, by which the advantages of conventional standard type scribing wheel and tooth type scribing wheel are integrated and the disadvantages thereof are avoided. The provided apparatus and method utilize the vibration to increase the depth of median crack without generating the lateral crack and reducing the bending strength, so that a breaking process is not necessary.

The present invention provides a vibration assistant scribing apparatus for generating an indentation having a median crack of a depth on a substrate, which includes a clamping device clamping a scribing wheel for scribing the substrate; a moving pedestal having a pressure device configured thereon, the pressure device providing a pressure to the scribing wheel through the clamping device; and a vibration generator configured on the clamping device and providing a vibration force to the scribing wheel through the clamping device, so as to increase the depth of the median crack thereby.

The present invention further provides a vibration assistant scribing method for generating an indentation having a median crack of a depth on a substrate, which includes the steps of providing a pressure to a clamping device and thus a scribing wheel clamped thereby; and providing a vibration force to the clamping device by a vibration generator configured thereon, so as to increase the depth of the median crack by the scribing wheel.

Preferably, the substrate is made of a hard brittle material, and more preferably, is a glass substrate or a wafer.

Preferably, the pressure device includes a motor configured on the moving pedestal and a force arm receiving a torque from the motor, so as to provide the scribing wheel with the pressure through the clamping device.

Preferably, the vibration generator is a piezoelectric actuator which receives a vibration wave signal by a piezoelectric driver to generate the vibration force. The vibration wave signal is one selected from a group consisting of a sawtooth wave, a square wave, a sine wave, and other wave shapes having the same effect.

By means of the piezoelectric actuator, the vibration assistant scribing apparatus according to the present invention is capable of generating a vibration at a high frequency, such that the scribing may be periodically varied. While applying to the standard type scribing wheel, the apparatus according to the present invention is able to significantly increase the depth of median crack to almost twice thereof. Moreover, the substrate may break by itself without reducing the strength at the edge thereof. In this case, the breaking process is not needed in the present invention, and an improved scribing effect is achieved with a relatively cheaper way by the present invention.

According to the present invention, the bending strength of a cut substrate is maintained at the same level with that of the standard type scribing wheel, and hence the disadvantages of the tooth type scribing wheel are avoided. The cost of scribing wheel and scribing apparatus may be saved by replacing the conventional tooth type scribing wheel with the design according to the present invention.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1 is a schematic view showing the scribing on a glass substrate by a scribing wheel in accordance with the prior art.

FIG. 2 is a cross sectional view of the glass substrate cut by the scribing wheel in accordance with the prior art.

FIGS. 3a and 3b are SEM photographs showing the conventional standard type and the tooth type scribing wheels, respectively.

FIG. 4 is a top view showing the glass substrate cut by the scribing wheel in accordance with the prior art.

FIG. 5 is a diagram schematically showing the difference in median cracks respectively generated by a non-vibration assistant scribing apparatus and a vibration assistant scribing apparatus according to one embodiment of the present invention.

FIG. 6A and FIG. 6B are schematic views showing the vibration assistant scribing apparatus according to one embodiment of the present invention.

FIG. 7A is a schematic view showing the scribing wheel track caused by the vibration assistant scribing apparatus according to the present invention using a triangle wave.

FIG. 7B is a schematic view showing the scribing wheel track caused by the vibration assistant scribing apparatus according to the present invention using a square wave.

FIG. 7C is a schematic view showing the scribing wheel track caused by the vibration assistant scribing apparatus according to the present invention using a sine wave.

FIG. 8 is a schematic view showing the shape of the cutting nose of scribing wheel according to the present invention.

FIG. 9 shows the relationship between the variation of vibration frequency and the depth of median crack generated by a 125-degree standard scribing wheel with a sine wave vibration, a square wave vibration and a sawtooth wave vibration according to the present invention.

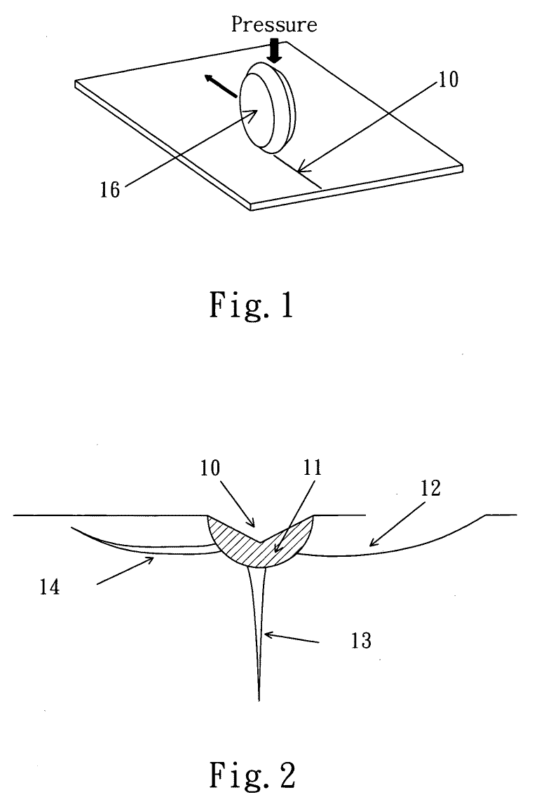

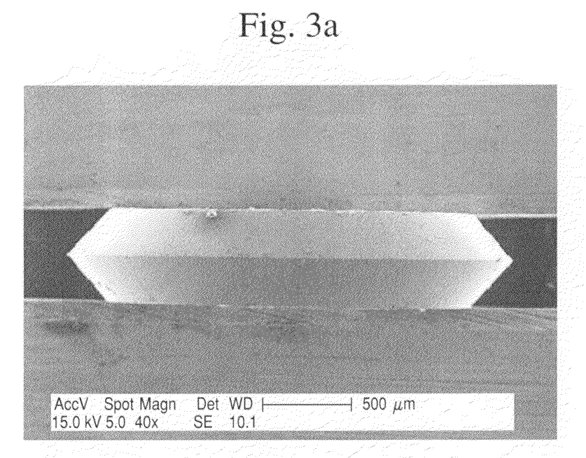

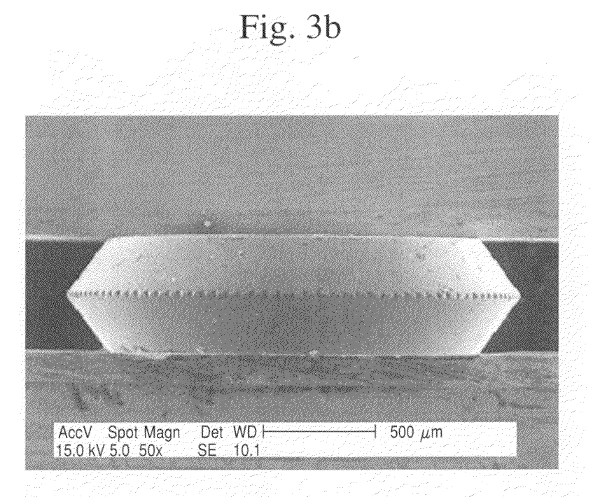

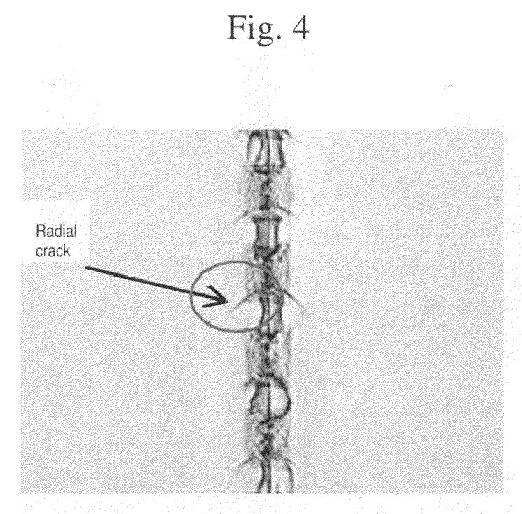

### DETAILED DESCRIPTION OF THE PREFERRED EMBODIMENTS

The present invention relates to a vibration assistant scribing apparatus, which utilizes a vibration assistant device to cause the scribing wheel cutting the substrate with a vibration manner, so as to increase the depth of the median crack, and further achieve the auto-breaking effect, wherein the substrate is made of a hard brittle material. In a preferred embodiment of the present invention, the substrate is one of a wafer and a glass substrate.

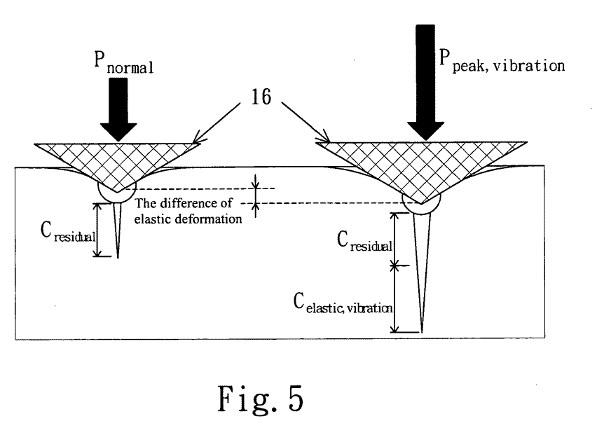

Please refer to FIG. 5, showing the difference between the median cracks generated by a conventional non-vibration assistant scribing apparatus and by the vibration assistant scribing apparatus according to the present invention, respectively. In one embodiment of the present invention, the substrate is an LCD panel. The left side of FIG. 5 shows the median crack 13 generated by the conventional non-vibration assistant scribing apparatus having a standard scribing wheel 16. The right side of FIG. 5 shows the median crack 13 generated by the standard scribing wheel 16 that is equipped in the vibration assistant scribing apparatus according to the present invention. In comparison, the present invention makes the constant loading (Pₙₒᵣₘₐₗ) increase to a peak loading value (P_{peak, vibration}) by vibration. Since the increasing loading is generated by contacting at a high speed, the residual of plastic components caused by increasing the loading can be avoided. Instead, the elastic components are also increased. As shown in FIG. 5, the depth of median crack is increased from C_{residual} which is made by the standard scribing manner to C_{residual} plus C_{elastic, vibration} which is generated by the elastic components. Such elastic components contribute little to the depth of median crack 13; however, a deliberate increase in the elastic components will affect the depth of median crack significantly.

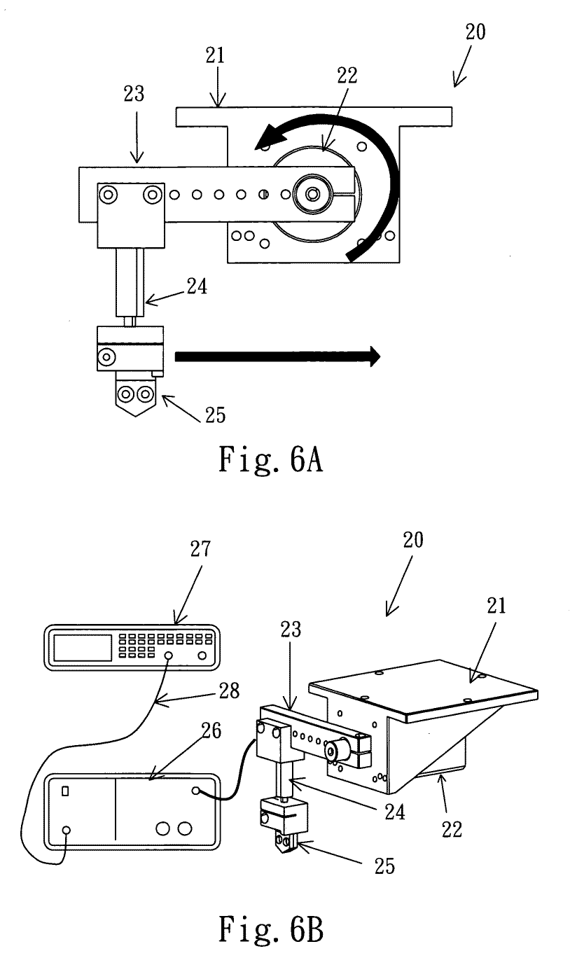

Refer to FIG. 6A and FIG. 6B, which schematically show the vibration assistant scribing apparatus according to the present invention. As shown in FIG. 6A and FIG. 6B, the vibration assistant scribing apparatus 20 includes a moving pedestal 21 which is driven by a driving mechanism (not shown) to move in a default direction. The moving pedestal 21 is provided with a motor 22 thereon, which has a main axis coupled to one end of a force arm 23 so as to provide a torque to the force arm 23 at one end and a pressure thereto at the other end. The motor 22 combined with the force arm 23 is an implementation of a pressure device, where the torque generated by the motor 22 may act on the scribing wheel as a pressure for generating the wheel indentation 10 in the scribing process. A clamping device 25 is configured to clamp a standard scribing wheel 16 thereon, and between the end of the force arm 23 and the clamping device 25, a vibration generator is configured.

In the preferred embodiment of the present invention, the scribing wheel is made of a super-hard material, which is one of the diamond material and the CBN (Cubic Boron Nitride) material. The diamond material is one of nature diamond and artificial diamond, while the artificial diamond is one of single crystal diamond and polycrystalline diamond.

In the preferred embodiment of the present invention, the vibration generator is implemented by a piezoelectric actuator 24, which provides a vibration force to the standard type scribing wheel 16 through the clamping device 25, so as to increase the depth of the median crack of the wheel indentation 10 thereby. The piezoelectric actuator 24 receives a vibration wave signal 28 and generates the vibration force in response thereto. The vibration wave signal is generated by a wave generator 27 at a vibration frequency. Such signal is transferred to the piezoelectric driver 26, so as to drive the piezoelectric actuator 24 to generate a periodic vibration, and thereby the depth of median crack 13 is improved. According to the preferred embodiment of the present invention, the vibration wave signal 28 is one of square wave, sine wave, cosine wave, triangle wave and any other wave having similar effects.

In one embodiment of the present invention, a vibration assistant scribing method for generating an indentation having a median crack of a depth on a substrate is also provided. The provided method is carried out with the aid of the vibration assistant scribing apparatus 20 according to the present invention. The present method includes a step of providing a pressure to a clamping device 25 by a pressure device. According to an embodiment of the present invention, the pressure device is constructed by a motor 22, which provides a torque to a force arm 23. Depending on receiving of the torque, the force arm 23 may provide the clamping device 25 with a corresponding pressure, which is further provided to the standard scribing wheel 16 clamped thereby in the scribing process. The present invention is advantageous in the configuration of a vibration generator on the clamping device 25, which provides the scribing wheel 16 with a vibration force through the clamping device 25, so as to increase the depth of median crack 13 thereby. In a preferred embodiment of the present invention, the vibration generator is implemented by a piezoelectric actuator 24, which is configured between the force arm 23 and the clamping device 25. The piezoelectric actuator 24 receives a vibration wave signal 24 at a vibration frequency and generates a vibration force for the scribing wheel 16 in response thereto.

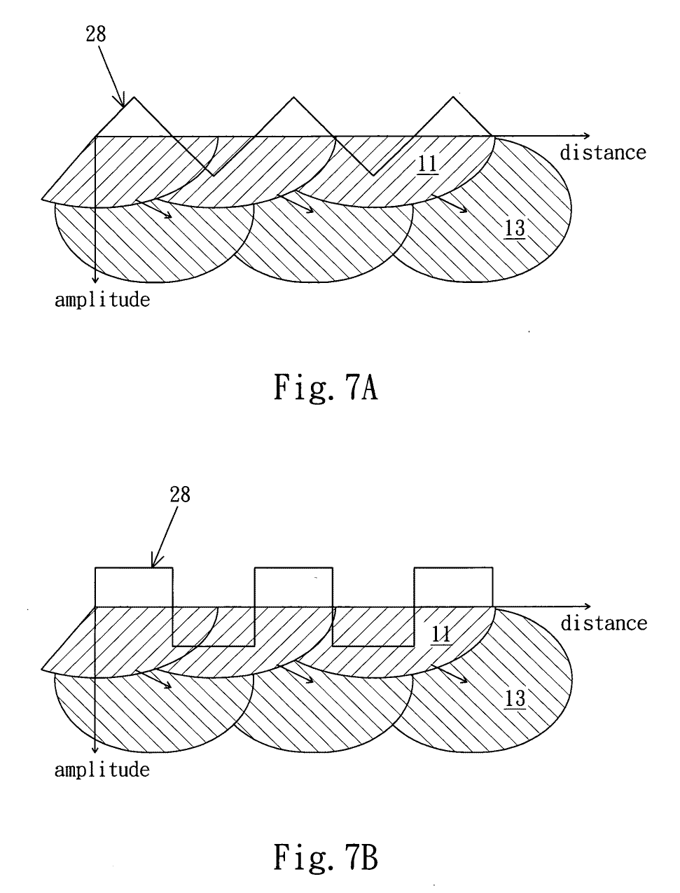

Please refer to FIG. 7A showing the scribing wheel track caused by the vibration assistant scribing apparatus of the present invention with the use of a triangle wave 28, which forms an area and median cracks. According to the present invention, the wave generator 27 generates triangle waves 28, which are transferred to a piezoelectric driver 26. The piezoelectric driver 26 drives the piezoelectric actuator 24 to generate a periodic vibration in response to the triangle wave 28, and additionally the motor 22 generates a torque causing the scribing wheel indentation 10 in the scribing process. In this case, a plastic deformation area 11 and a median crack 13 as shown in FIG. 7A are achieved, which is exactly desired for the present invention.

Please refer to FIG. 7B, showing the scribing wheel track caused by the vibration assistant scribing apparatus of the present invention with the use of a square wave 28, which forms an area and median cracks. In the embodiment of the present invention, the wave generator 27 generates square waves 28, which are transferred to a piezoelectric driver 26. The piezoelectric driver 26 drives the piezoelectric actuator 24 to generate a periodic vibration in response to the square wave 28, and additionally the motor 22 generates a torque causing the scribing wheel indentation 10 in the scribing process. In this case, a plastic deformation area 11 and a median crack 13 as shown in FIG. 7B are achieved, which is exactly desired for the present invention.

Please refer to FIG. 7C, showing the scribing wheel track caused by the vibration assistant scribing apparatus of the present invention with the use of a sine wave 28, which forms an area and median cracks. In the embodiment of the present invention, the wave generator 27 generates sine waves 28, which are transferred to a piezoelectric driver 26. The piezoelectric driver 26 drives the piezoelectric actuator 24 to generate a periodic vibration in response to the sine wave 28, and additionally the motor 22 generates a torque causing the scribing wheel indentation 10 in the scribing process. In this case, a plastic deformation area 11 and a median crack 13 as shown in FIG. 7C are achieved, which is exactly desired for the present invention.

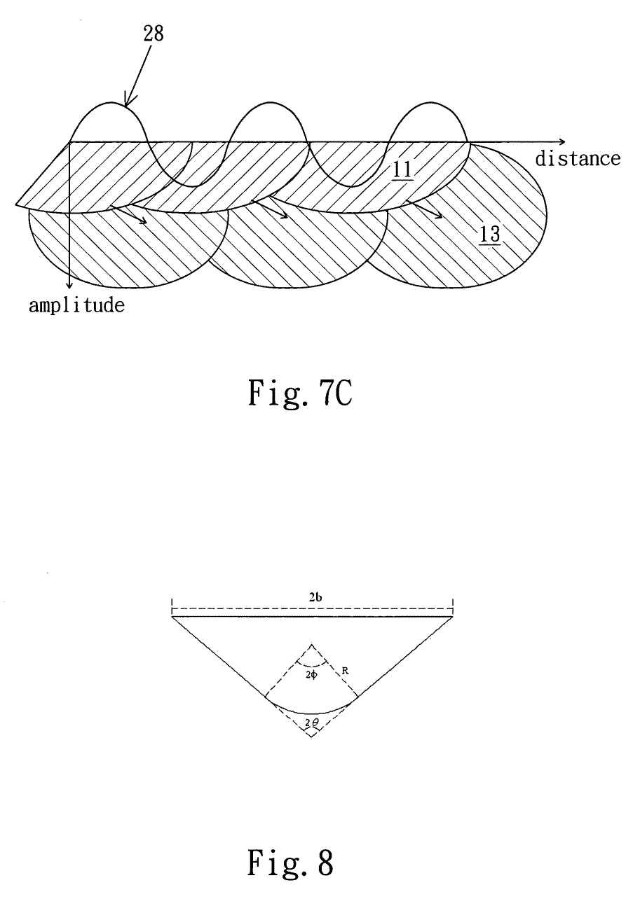

In the present invention, the vibration assistant scribing apparatus and the method thereof as provided is carried out for processing a glass substrate. In one embodiment of the present invention, the scribing speed is set to 100 mm/s, the amplitude of the vibration wave signal is set to ±8 μm. A 125-degree standard scribing wheel with sine wave, square wave and triangle wave, respectively is applied to proceed the scribing process, in which the loading is 1500 g, and the vibration frequency is set ranged from 200 Hz to 2 KHz. FIG. 8 is a schematic diagram showing the shape of the scribing wheel cutting nose, wherein the width of the indentation is 2b, the angle of the scribing wheel is 2θ, the nose radius is R and the central angle is 2φ). According to a preferred embodiment of the present invention, the nose radius and the central angle of the 125-degree standard scribing wheel is chosen as 5.4 μm and 58 degree, respectively.

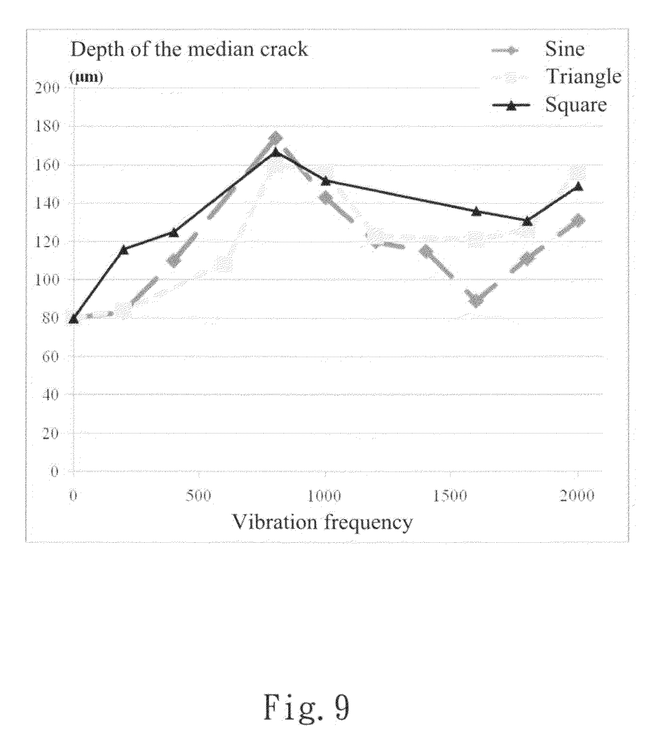

Please refer to FIG. 9 showing the relationship between the variation of vibration frequency and the depth of median crack generated by a 125-degree standard scribing wheel with a sine wave vibration, a square wave vibration and a sawtooth wave vibration according to the present invention. In this embodiment, the vibration frequency of 0 Hz indicates a non-vibration assistant scribing process, and the depth of the median crack caused by the 125-degree standard scribing wheel under such situation is 80 μm. It is clear from FIG. 9 that the vibration assistant scribing apparatus brings an improved median crack for the substrate, in which the depth thereof is much increased, no matter the sine wave, the square wave, or the triangle wave is applied therefor. It is also found in the present invention that a vibration frequency of 800 Hz results in a most enhanced median crack for a glass substrate in which the depth of the median crack is twice than the depth generated in a non-vibration assistant scribing process. It is known to the skill person in this art that an auto-breaking of the glass substrate may occur if the depth of median crack exceeds 140 μm, and therefore, it is clear that such effect is achieved by the present invention, without generating lateral cracks for the substrate.

Although example embodiments of the invention have been described in some detail for purposes of clarity of understanding, it will be apparent that certain changes and modifications can be practiced within the scope of the following claims. For example, the frequency of the vibration wave ranged from 20 Hz to 20000 Hz, the amplitude of the vibration wave ranged from ±1 μm to ±50 μm, and the vibration assistant scribing apparatus having a loading ranged from 10 g to 5000 g are all possible for the present invention.

Accordingly, the present embodiments are to be considered as illustrative and not restrictive, and the invention is not to be limited to the details given herein, but may be modified within the scope and equivalents of the following claims. In the following claims, elements and/or steps do not imply any particular order of operation, unless explicitly stated in the claims or implicitly required by the specification and/or drawings.

What is claimed is:

1. A vibration assistant scribing apparatus for generating an indentation having a median crack of a depth on a substrate, comprising:
a clamping device clamping a scribing wheel for scribing said substrate;
a moving pedestal having a pressure device configured thereon, said pressure device providing a pressure to said scribing wheel through said clamping device; and
a vibration generator configured on said clamping device and providing a vibration force to said scribing wheel through said clamping device, so as to increase said depth of said median crack thereby.

2. The vibration assistant scribing apparatus according to claim 1, wherein said substrate is one selected from a group consisting of a glass substrate, a wafer and a substrate made of hard brittle material.

3. The vibration assistant scribing apparatus according to claim 1, wherein said pressure device comprises a motor configured on said moving pedestal and a force arm receiving a torque from said motor, and said vibration generator is configured between said force arm and said clamping device, so as to provide said pressure to said scribing wheel by said force arm and through said clamping device.

4. The vibration assistant scribing apparatus according to claim 1, wherein said vibration generator is a piezoelectric actuator receiving a vibration wave signal through a piezoelectric driver, so as to generate said vibration force.

5. The vibration assistant scribing apparatus according to claim 4, wherein said vibration wave signal is one selected from a group consisting of a sawtooth wave, a square wave and a sine wave provided by a wave generator.

6. The vibration assistant scribing apparatus according to claim 4, wherein said scribing wheel is a 125-degree standard scribing wheel having a scribing speed of 100 mm/s, and said vibration wave signal has a frequency of 800 Hz.

7. The vibration assistant scribing apparatus according to claim 4, wherein said vibration wave signal has a frequency ranged from 20 Hz to 20000 Hz and an amplitude ranged from ±1 μm to ±50 μm, and said vibration assistant scribing apparatus has a loading ranged from 10 g to 5000 g.

8. The vibration assistant scribing apparatus according to claim 1, further comprising:
a wave generator generating a vibration wave signal; and
a piezoelectric driver driving said vibration generator to generate said vibration force in response to said vibration wave signal, wherein said vibration generator is a piezoelectric actuator.

9. The vibration assistant scribing apparatus according to claim 1, wherein said scribing wheel is made of a super-hard material.

10. The vibration assistant scribing apparatus according to claim 1, wherein said super-hard material is one of a diamond material and a CBN (Cubic Boron Nitride) material, wherein said diamond material is one of a nature diamond and an artificial diamond, and wherein said artificial diamond is one of a single crystal diamond and a polycrystalline diamond.

11. A vibration assistant scribing method for generating an indentation having a median crack of a depth on a substrate, comprising:
providing a pressure to a clamping device and thus a scribing wheel clamped thereby; and
providing a vibration force to said clamping device by a vibration generator configured thereon, so as to increase said depth of said median crack by said scribing wheel.

12. The vibration assistant scribing method according to claim 11, wherein said substrate is one selected from a group consisting of a glass substrate, a wafer and a substrate made of hard brittle material.

13. The vibration assistant scribing method according to claim 11, wherein said vibration generator is a piezoelectric actuator receiving a vibration wave signal through a piezoelectric driver, so as to generate said vibration force.

14. The vibration assistant scribing method according to claim 13, wherein said vibration wave signal is one selected from a group consisting of a sawtooth wave, a square wave and a sine wave provided by a wave generator.

15. The vibration assistant scribing method according to claim 13, wherein said scribing wheel is a 125-degree standard scribing wheel having a scribing speed of 100 mm/s, and said vibration wave signal has a frequency of 800 Hz.

16. The vibration assistant scribing method according to claim 11, further comprising:
generating a vibration wave signal by a wave generator; and
receiving said vibration wave signal by a piezoelectric driver, so as to drive said vibration generator to generate said vibration force, wherein said vibration generator is a piezoelectric actuator.

17. The vibration assistant scribing method according to claim 11, wherein said scribing wheel is made of a super-hard material.

18. The vibration assistant scribing method according to claim 17, wherein said super-hard material is one of a diamond material and a CBN (Cubic Boron Nitride) material.

19. The vibration assistant scribing method according to claim 18, wherein said diamond material is one of a nature diamond and an artificial diamond.

20. The vibration assistant scribing method according to claim 19, wherein said artificial diamond is one of a single crystal diamond and a polycrystalline diamond.
